(19) United States
(12) Patent Application Publication
(10) Pub. No.: US 2005/0086594 A1
(43) Pub. Date: Apr. 21, 2005

(54) Mixed content includes and encodes

(76) Inventors: Jeffrey C. Schlimmer, Redmond, WA (US); Martin J. Gudgin, Cheshire (GB); Donald F. Box, Bellevue, WA (US); Christopher G. Kaler, Sammamish, WA (US); Timothy J. Ewald, Nashua, NH (US); Yasser Shohoud, Sammamish, WA (US)

Correspondence Address: LEE & HAYES PLLC, 421 W RIVERSIDE AVENUE SUITE 500, SPOKANE, WA, 99201, US

(21) Appl. No.: 10/685,764

(22) Filed: Oct. 15, 2003

(51) Int. Cl. G06F 17/00

(52) U.S. Cl. 715/515; 715/516; 715/513; 715/500.1; 715/501.1

(57) ABSTRACT

Information that is encoded in different character sets can be combined within a single package without having to perform character set-to-character set encodings, either by interleaving the data or by referencing the data.

### FIELD

The example embodiments described herein relate to the representation of at least opaque binary data as content in electronic files.

### BACKGROUND

As usage of XML (Extensible Markup Language) as a message format has increased, so has interest in integrating opaque binary data with XML.

Emerging text-based formats requiring heterogeneous, character-based information or embedded binary data mostly use either inefficient encodings or one-off solutions for handling mixed data. Examples of such encoding include base64 or similar encode mechanisms such as uuencode or hexadecimal, all of which increases data to such an extent that the processing overhead for an associated conversion also increases significantly. Such an increase in data size is sometimes referred to as a data “bloat.” Similar problems exist with respect to representing heterogeneous text data; because the data can be large, the processing cost of normalization for a single character set increases correspondingly if not exponentially. Furthermore, even though opaque data whose native representation is a sequence of octets may be encoded as base64 text in XML elements without loss of information, such information is not captured in any XML Schema.

Thus, there is a desire to integrate XML with pre-existing data formats that do not readily adhere to XML syntax, while keeping the non-XML formats intact, i.e., they would be treated as opaque sequences of octets by XML tools and infrastructure.

### SUMMARY

Mixed content encoding and attachments are described herein.

By combining data having at least two different encodings and presenting the combined data as homogenized data according to a reference encoding, information that is encoded in different character sets can be combined within a single package without having to perform character set-to-character set encodings.

### BRIEF DESCRIPTION OF THE DRAWINGS

The scope of the present invention will be apparent from the following detailed description, when taken in conjunction with the accompanying drawings, and such detailed description, while indicating embodiments of the invention, are given as illustrations only, since various changes and modifications will become apparent to those skilled in the art from the following detailed description, in which:

FIG. 1 is a flow chart showing general processing flow according to an example embodiment;

FIG. 2 shows an example of a data format resulting from the processing of FIG. 1;

FIG. 3 shows another example of a data format resulting from the processing of FIG. 1; and

FIG. 4 illustrates a general computer environment which can be used to implement the techniques described herein.

### DETAILED DESCRIPTION

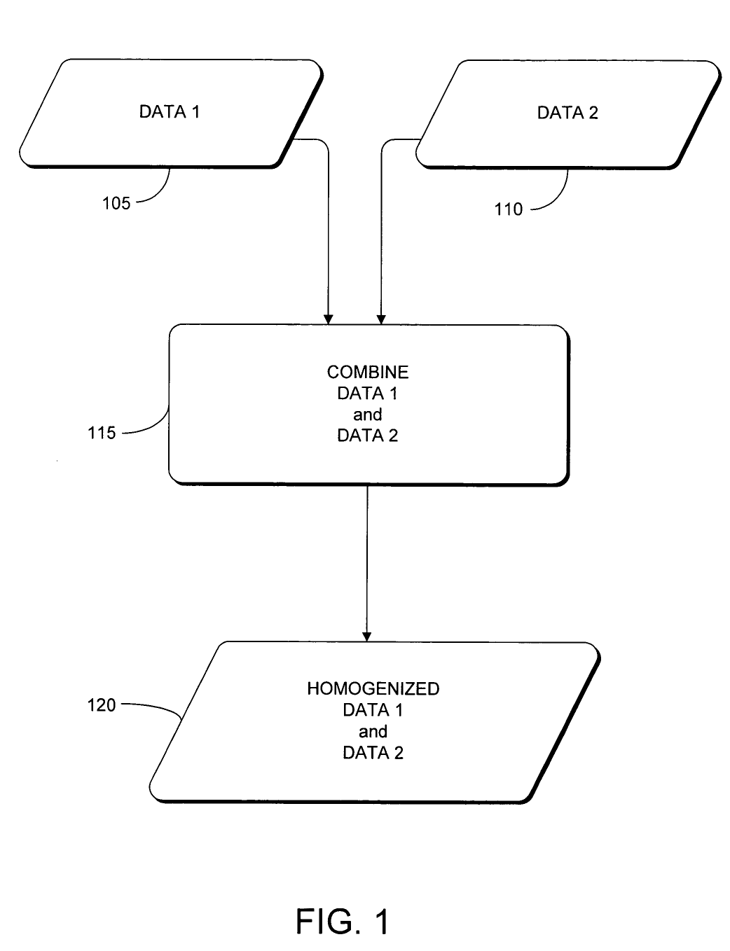

FIG. 1 shows an example flowchart for combining data formats. Such combined formats may be utilized for text composition, electronic messaging, web-posts, etc. That is, the processing of FIG. 1 combines data sets, at least two of which are encoded differently, for presentation in a singular document or electronic format.

According to FIG. 1, Data1 105 is encoded according to a first format, e.g., XML; and Data2 110 is encoded according to a second format, e.g., JPEG. Using one of one or more different combination techniques 115, Data1 105 and Data2 110 are combined as homogenized data according to a reference encoding, such as XML. Specifically, combination techniques 115 include “mixed content includes” (also referred herein as “mixed content attachments”) and “mixed content encoding.”

The present description includes references to “opaque binary data” or “opaque data.” Such references are to data, binary or otherwise, whose declaration or encoding type is deferred.

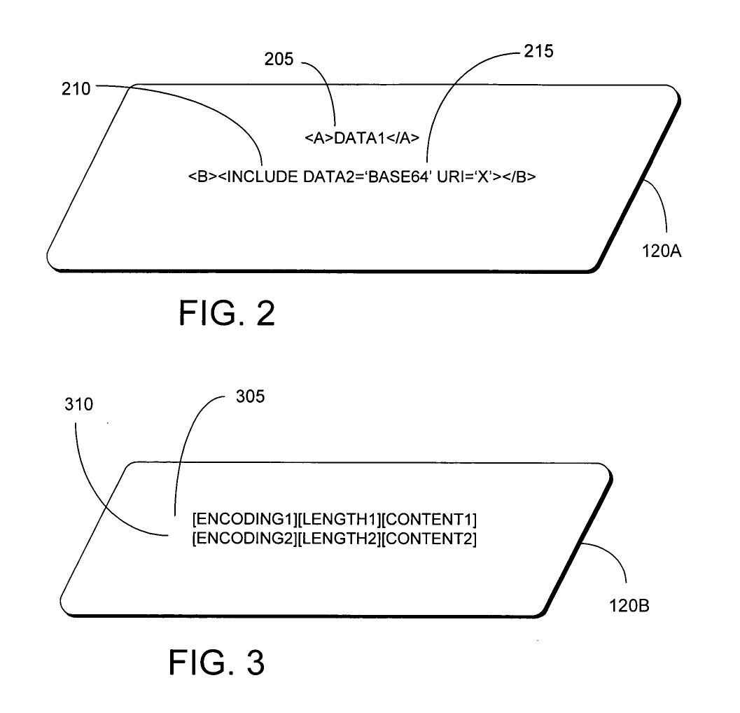

The homogenized data of FIG. 2 enables applications to avoid the data bloat and resultant increase in overhead associated with base64 encoding in accordance with the mixed content includes combination technique. More specifically, FIG. 2, which shows an example of homogenized data 120A resulting from the processing of the example of FIG. 1, provides XML “include” element 210 that references opaque binary Data2 215 to be included in a character, e.g., text, string. The opaque binary data is referenced by XML include element 210, which is a uniform resource identifier (hereafter “URI”), and the resultant version of an octet sequence, in base64, logically replaces the include element. Accordingly, an XML processor processes as if all binary data is base64-encoded character content, independent of the wire format of the content, allowing the processor to apply an Infoset-based processing model to the content. More particularly, XML include element 210 references opaque binary Data2 215 for logical inclusion, and carries a single attribute. A href (Hypertext REFerence) attribute of XML include element 210 provides the URI of the opaque binary data to be included. The normalized value of the href attribute resolves to a resource within the message serialization. A base64-encoding of the octet stream resulting from resolving the URI replaces the XML include element that the URI attribute appears on. It should be noted that, as utilized within this description, the term “resolve” refers to linking or pointing to referenced data.

A “SOAP” header block for XML include element 210 indicates that messages should be processed for XML include elements. “SOAP” used to denote a Simple Object Access Protocol. However, SOAP is now understood to denote a lightweight protocol intended for exchanging structured information in a decentralized, distributed environment. SOAP utilizes XML technologies to define an extensible messaging framework, which provides a message construct that can be exchanged over a variety of underlying protocols. The framework has been designed to be independent of any particular programming model and other implementation specific semantics. Accordingly, the SOAP header block is a required presence for an XML include element to be implemented. Further still, the header block is invoked upon access, and should be invoked in a processing model before any other header block that references or manipulates the data within, otherwise, the XML include element could be invoked just once at the start of message processing, thus unnecessarily taxing the processing overhead.

The following example illustrates the use of an XML include element in a multipart MIME serialization. While the example shows all opaque binary data being carried in multipart MIME packaging, this is not an intrinsic characteristic of XML include processing. That is, XML include elements can be used with other message serialization schemes.

MIME-Version: 1.0
Content-Type: Multipart/Related; boundary=MIME_boundary;
type=text/xml;
start=“<mymessage.xml@example.org>”
Content-Description: An XML document with my pic, warcry
and sig in it
--MIME_boundary
Content-Type: text/xml; charset=UTF-8
Content-Transfer-Encoding: 8bit
Content-ID: <mymessage.xml@example.org>
<soap:Envelope xmlns:soap=‘http://www.w3.org/2002/12/soap-
envelope’
xmlns:xbinc=‘http://schemas.xmlsoap.org/2003/04/xbinc’
xmlns:xmime=‘http://schemas.xmlsoap.org/2003/04/xmime’ >

<soap:Header>

<xbinc:DoInclude

soap:role=‘http://www.w3.org/2002/12/soap-

envelope/role/next’

soap:mustUnderstand=‘false’
soap:relay=‘true’ />

</soap:Header>
<soap:Body>

<m:data xmlns:m=‘http://example.org/stuff’ >

<m:photo xmime:MediaType=‘image/png’ >

<xbinc:Include href=‘cid:http://example.org/me.png’ />

</m:photo>
<m:sound xmime:MediaType=‘audio/mpeg’ >

<xbinc:Include href=‘cid:http://example.org/it.mp3’ />

</m:sound>
<m:sig xmime:MediaType=‘application/pkcs7-signature’ >

<xbinc:Include href=‘cid:http://example.org/my.hsh’ />

</m:sig>

</m:data>

</soap:Body>

</soap:Envelope>
--MIME_boundary
Content-Type: image/png
Content-Transfer-Encoding: binary
Content-ID: <http://example.org/me.png>
fd a5 8a 29 aa 46 1b 24
--MIME_boundary
Content-Type: audio/mpeg
Content-Transfer-Encoding: binary
Content-ID: <http://example.org/it.mp3>
b1 d7 1f a3 62 53 89 71
--MIME_boundary
Content-Type: application/pkcs7-signature
Content-Transfer-Encoding: binary
Content-ID: <http://example.org/my.hsh>
15 a6 bb bd 13 a2 d9 54
--MIME_boundary--

The resultant Infoset is the same as that of the following:

<soap:Envelope xmlns:soap=‘http://www.w3.org/2002/12/soap-
envelope’
xmlns:xbinc=‘http://schemas.xmlsoap.org/2003/04/xbinc’
xmlns:xmime=‘http://schemas.xmlsoap.org/2003/04/xmime’ >

<soap:Header>

<xbinc:DoInclude

soap:role=‘http://www.w3.org/2002/12/soap-

envelope/role/next’

soap:mustUnderstand=‘false’
soap:relay=‘true’ />

</soap:Header>
<soap:Body>

<m:data xmlns:m=‘http://example.org/stuff’ >

<m:photo xmime:MediaType=‘image/png’ >

/aWKKapGGyQ=

</m:photo>
<m:sound xmime:MediaType=‘audio/mpeg’ >

sdcfo2JTiXE=

</m:sound>
<m:sig xmime:MediaType=‘application/pkcs7-signature’ >

Faa7vROi2VQ=

</m:sig>

</m:data>

</soap:Body>

</soap:Envelope>

The following technique provides the ability to add MIME type information to opaque binary data in XML. This technique is applicable whether or not the opaque binary data is in fact associated with a URI-based web reference.

In particular, where a MediaType attribute specifies a media type of the base64-encoded content of its element, such as JPEG or WAV, a corresponding normalized value is a media type. A BinaryType attribute is an XML Schema attribute having a base xs:base64Binary, and further carries an optional xmime:MediaType attribute. That is, the BinaryType can be used by elements that need to carry base64-encoded data along with optional media type information.

In the following example, the m:photo, m:sound, and m:sig elements are of type xmime:Binary. The xmime:MediaType attribute defined for that type labels the MIME type of the base64-encoded content for each of these elements. This message may be correctly processed by other known SOAP nodes.

<soap:Envelope xmlns:soap=‘http://www.w3.org/2002/12/soap-
envelope’
xmlns:xmime=‘http://schemas.xmlsoap.org/2003/04/xmime’ >

<soap:Body>

<m:data xmlns:m=‘http://example.org/stuff’ >

<m:photo xmime:MediaType=‘image/png’ >

/aWKKapGGyQ=

</m:photo>
<m:sound xmime:MediaType=‘audio/mpeg’ >

sdcfo2JTiXE=

</m:sound>
<m:sig xmime:MediaType=‘application/pkcs7-signature’ >

Faa7vROi2VQ=

</m:sig>

</m:data>

</soap:Body>

</soap:Envelope>

At least one scenario that is not completely satisfied by the technique described above involves message content containing URI-based web references, whereby a message sender desires to send the representations behind such references as part of an aggregate message. To implement such an aggregate message, a SOAP header block is provided to allow a SOAP node to send cached representations of web resources to either the ultimate receiver or a specific intermediary. Further, the representation element contains base64-encoded content, carries a href attribute, and, optionally, a xmime:MediaType attribute as defined above.

The content of the XML include element is the base64-encoding of the web resource referred to by the URI attribute. The URIs used to represent web sources should be appropriately secured if they are to be used by applications that resolve URIs. Specifically, when a URI is dereferenced, the contents of the representation element with the matching URI attribute value are used as the representation returned if it is appropriately secured.

The value of the URI attribute specifies the identifier of the web resource corresponding to the base64-encoded representation contained by the representation element. When comparing URIs to find an appropriate representation:
if an absolute URI is given, then the scheme name should treat upper-case letters as equivalent to lower case; and
if a scheme appears to follow the “Generic URI” syntax for representing hierarchical relationships and uses a Server-based Naming Authority, then domain name comparisons are done in a case-insensitive manner, assuming an ASCII character set, and a high order zero bit.

According to the following example embodiment, a representation of an external resource, an image, is cached with the SOAP message. The representation of the image is carried in a representation header block in the SOAP message. The representation is referred to by the source attribute of an image element in the body of the message.

<soap:Envelope xmlns:soap=‘http://www.w3.org/2002/

12/soap-envelope’
xmlns:swa=‘http://schemas.xmlsoap.org/2003/04/swa’
xmlns:xmime=‘http://schemas.xmlsoap.org/2003/04/xmime’ >

<soap:Header>

<swa:Representation URI=‘http://example.org/me.png’

xmime:MediaType=‘image/png’ >

/aWKKapGGyQ=

</swa:Representation

</soap:Header>
<soap:Body>

<x:MyData xmlns:x=‘http://example.org/mystuff’ >

<x:name>Don Box</x:name>
<x:img x:src=‘http://example.org/me.png’ />

</x:MyData>

</soap:Body>

</soap:Envelope>

Combining this header with the XML include element described above yields the following serialization:

MIME-Version: 1.0

Content-Type: Multipart/Related; boundary=MIME_boundary;
type=text/xml;
start=“<mymessage.xml@example.org>”
Content-Description: An XML document with my picture
--MIME_boundary
Content-Type: text/xml; charset=UTF-8
Content-Transfer-Encoding: 8bit
Content-ID: <mymessage.xml@example.org>
<soap:Envelope xmlns:soap=‘http://www.w3.org/2002/12/soap-
envelope’
xmlns:swa=‘http://schemas.xmlsoap.org/2003/04/swa’
xmlns:xbinc=‘http://schemas.xmlsoap.org/2003/04/xbinc’
xmlns:xmime=‘http://schemas.xmlsoap.org/2003/04/xmime’ >

<soap:Header>

<xbinc:DoInclude

soap:role=‘http://www.w3.org/2002/12/soap-

envelope/role/next’

soap:mustUnderstand=‘false’
soap:relay=‘true’ />

<swa:Representation URI=‘http://example.org/me.png’

xmime:MediaType=‘image/png’ >

<xbinc:Include href=‘cid:me@example.com’ />

</swa:Representation>

</soap:Header>
<soap:Body>

<x:MyData xmlns:x=‘http://example.org/mystuff’ >

<x:name>Don Box</x:name>
<x:img src=‘http://example.org/me.png’ />

</x:MyData>

</soap:Body>

</soap:Envelope>
--MIME_boundary
Content-Type: image/png
Content-Transfer-Encoding: binary
Content-ID: <me@example.com>
fd a5 8a 29 aa 46 1b 24
--MIME_boundary--

In a further example, a SOAP message includes multiple references to a particular cached resource. The representation of the resource, e.g., an image, is carried in a representation header block and is referred to by the source attribute of an image and a picture element in the body of the message.

<soap:Envelope xmlns:soap=‘http://www.w3.org/2002/12/soap-

envelope’
xmlns:swa=‘http://schemas.xmlsoap.org/2003/04/swa’
xmlns:xmime=‘http://schemas.xmlsoap.org/2003/04/xmime’ >

<soap:Header>

<swa:Representation URI=‘http://example.org/me.png’

xmime:MediaType=‘image/png’ >

/aWKKapGGyQ=

</swa:Representation>

</soap:Header>
<soap:Body>

<x:MyData xmlns:x=‘http://example.org/mystuff’ >

<x:name>Don Box</x:name>
<x:img x:src=‘http://example.org/me.png’ />

</x:MyData>
<y:AltData xmlns:y=‘http://example.org/altstuff’ >

<y:name>

<y:given>Don</y:given>
<y:surname>Box</y:surname>

</y:name>
<y:picture y:src=‘http://example.org/me.png’ />

</y:AltData>

</soap:Body>

</soap:Envelope>

The representation header block in this example could be combined with an XML include element to yield an alternate serialization.

In yet another example, a SOAP message does not explicitly reference a resource, but rather a cached representation of the resource is included for application processing. The representation of the e.g., media, resource is carried in a representation header block.

<soap:Envelope xmlns:soap=‘http://www.w3.org/2002/12/soap-

envelope’
xmlns:swa=‘http://schemas.xmlsoap.org/2003/04/swa’
xmlns:xmime=‘http://schemas.xmlsoap.org/2003/04/xmime’ >

<soap:Header>

<swa:Representation URI=‘http://example.org/alert.mp3’

xmime:MediaType=‘audio/mpeg’ >

sdcfo2JTiXE=

</swa:Representation>

</soap:Header>
<soap:Body>

<x:MyData xmlns:x=‘http://example.org/mystuff’ >

<x:name>Don Box</x:name>

</x:MyData>

</soap:Body>

</soap:Envelope>

The representation header block in this example could be combined with an XML include element to yield an alternate serialization.

The SOAP processing model is defined in terms of an Infoset. As described above, processing behaves as if the XML include element header is processed first. SOAP messages containing an XML include element are treated as if SOAP processing occurs post-inclusion. Thus, if a SOAP header block referring to opaque data via an XML include element is removed by an intermediary, the opaque data is also removed from the message.

Since the XML include element is transfer syntax, if a SOAP intermediary forwards a message, it may serialize opaque data in the message Infoset using base64 encoding or using an XML include element independent of the original message transfer syntax.

For example, if the following message arrives at a security intermediary which acts in the role ‘http://schemas.xmlsoap.org/security’:

MIME-Version: 1.0

Content-Type: Multipart/Related; boundary=MIME_boundary;
type=text/xml;
start=“<mymessage.xml@example.org>”
Content-Description: A SOAP envelope containing a thumbprint
image for authentication purposes
--MIME_boundary
Content-Type: text/xml; charset=UTF-8
Content-Transfer-Encoding: 8bit
Content-ID: <mymessage.xml@example.org>
<soap:Envelope xmlns:soap=‘http://www.w3.org/2002/12/soap-
envelope’
xmlns:xbinc=‘http://schemas.xmlsoap.org/2003/04/xbinc’
xmlns:xmime=‘http://schemas.xmlsoap.org/2003/04/xmime’

xmlns:m=‘http://example.org/stuff’ >

<soap:Header>

<xbinc:DoInclude

soap:role=‘http://www.w3.org/2002/12/soap-

envelope/role/next’

soap:mustUnderstand=‘false’
soap:relay=‘true’ />

<m:Thumbprint xmime:MediaType=‘image/png’

soap:role=‘http://schemas.xmlsoap.org/security’ >

<xbinc:Include href=‘cid:http://example.org/thumb.png’ />

</m:Thumbprint>

</soap:Header>
<soap:Body>

<m:sound xmime:MediaType=‘audio/mpeg’ >

<xbinc:Include href=‘cid:http://example.org/it.mp3’ />

</m:sound>

</soap:Body>

</soap:Envelope>
--MIME_boundary
Content-Type: image/png
Content-Transfer-Encoding: binary
Content-ID: <http://example.org/thumb.png>
fd a5 8a 29 aa 46 1b 24
--MIME_boundary
Content-Type: audio/mpeg
Content-Transfer-Encoding: binary
Content-ID: <http://example.org/it.mp3>
b1 d7 1f a3 62 53 89 71
--MIME_boundary--

the resultant Infoset is the same as that of the following:

<soap:Envelope xmlns:soap=‘http://www.w3.org/2002/12/soap-

envelope’
xmlns:xbinc=‘http://schemas.xmlsoap.org/2003/04/xbinc’
xmlns:xmime=‘http://schemas.xmlsoap.org/2003/04/xmime’

xmlns:m=‘http://example.org/stuff’ >

<soap:Header>

<xbinc:DoInclude

soap:role=‘http://www.w3.org/2002/12/soap-

envelope/role/next’

soap:mustUnderstand=‘false’
soap:relay=‘true’ />

<m:Thumbprint xmime:MediaType=‘image/png’

soap:role=‘http://schemas.xmlsoap.org/security’ >

/aWKKapGGyQ=

</m:Thumbprint>

</soap:Header>
<soap:Body>

<m:sound xmime:MediaType=‘audio/mpeg’ >

sdcfo2JTiXE=

</m:sound>

</soap:Body>

</soap:Envelope>

Further, after processing by the security intermediary the resultant Infoset is the same as that of the following:

<soap:Envelope xmlns:soap=‘http://www.w3.org/2002/12/soap-

envelope’
xmlns:xbinc=‘http://schemas.xmlsoap.org/2003/04/xbinc’
xmlns:xmime=‘http://schemas.xmlsoap.org/2003/04/xmime’

xmlns:m=‘http://example.org/stuff’ >

<soap:Header>

<xbinc:DoInclude

soap:role=‘http://www.w3.org/2002/12/soap-

envelope/role/next’

soap:mustUnderstand=‘false’
soap:relay=‘true’ />

</soap:Header>
<soap:Body>

<m:sound xmime:MediaType=‘audio/mpeg’ >

sdcfo2JTiXE=

</m:sound>

</soap:Body>

</soap:Envelope>

Thus, the security intermediary may choose to serialize that Infoset as the following:

MIME-Version: 1.0

Content-Type: Multipart/Related; boundary=MIME_boundary;
type=text/xml;
start=“<mymessage.xml@example.org>”
Content-Description: A SOAP envelope containing a thumbprint
image for authentication purposes
--MIME_boundary
Content-Type: text/xml; charset=UTF-8
Content-Transfer-Encoding: 8bit
Content-ID: <mymessage.xml@example.org>
<soap:Envelope xmlns:soap=‘http://www.w3.org/2002/12/soap-
envelope’
xmlns:xbinc=‘http://schemas.xmlsoap.org/2003/04/xbinc’
xmlns:xmime=‘http://schemas.xmlsoap.org/2003/04/xmime’

xmlns:m=‘http://example.org/stuff’ >

<soap:Header>

<xbinc:DoInclude

soap:role=‘http://www.w3.org/2002/12/soap-

envelope/role/next’

soap:mustUnderstand=‘false’
soap:relay=‘true’ />

</soap:Header>
<soap:Body>

<m:sound xmime:MediaType=‘audio/mpeg’ >

<xbinc:Include href=‘cid:http://example.org/it.mp3’ />

</m:sound>

</soap:Body>

</soap:Envelope>
--MIME_boundary
Content-Type: audio/mpeg
Content-Transfer-Encoding: binary
Content-ID: <http://example.org/it.mp3>
b1 d7 1f a3 62 53 89 71
--MIME_boundary--

Applications sometimes require a set of acceptable media types to be specified for opaque binary data. Accordingly, xmime:Accept can be used to annotate schema declarations of elements of type xmime:Binary. This Accept attribute may be used on element declarations in schema to specify a list of accepted media types of the base64-encoded content of instances of the element. The normalized value of the Accept attribute is a space-delimited list of media types with “q” parameters. When the Accept attribute is not present the media type “*/*” is assumed.

The following WSDL shows an example message that contains an element of type xmime:Binary:

<wsdl:definitions

xmlns:wsdl=“http://schemas.xmlsoap.org/wsdl/”
targetNamespace=“http://example.org/CustomerExample”
xmlns:tns=“http://example.org/CustomerExample”
xmlns:xs=“http://www.w3.org/2001/XMLSchema”
xmlns:soap=“http://schemas.xmlsoap.org/wsdl/soap/” >

<wsdl:types>

<xs:schema xmlns=“http://www.w3.org/2001/XMLSchema”

targetNamespace=“http://example.org/CustomerExample”
xmlns:xmime=“http://schemas.xmlsoap.org/2003/04/xmime” >

<xs:import

namespace=“http://schemas.xmlsoap.org/2003/04/xmime” />

<xs:element name=“Customer” >

<xs:complexType>

<xs:sequence>

<xs:element name=“Name” type=“xs:string” />
<xs:element name=“Photo”

type=“xmime:Binary”

xmime:Accept=“image/jpeg image/gif;p=0.5” />

</xs:sequence>

</xs:complexType>

</xs:element>
<xs:element name=“Status” type=“xs:string” />

</xs:schema>

</wsdl:types>
<wsdl:message name=“InMessage” >

<wsdl:part name=“InPart” element=“tns:Customer” />

</wsdl:message>
<wsdl:message name=“OutMessage” >

<wsdl:part name=“OutPart” element=“tns:Status” />

</wsdl:message>
<wsdl:portType name=“ThePortType” >

<wsdl:operation name=“CustomerInfo” >

<wsdl:input message=“tns:InMessage” />
<wsdl:output message=“tns:OutMessage” />

</wsdl:operation>

</wsdl:portType>
<wsdl:binding name=“SoapBinding” type=“tns:ThePortType” >

<soap:binding transport=“http://schemas.xmlsoap.org/soap/http”

/>

<wsdl:operation name=“CustomerInfo” >

<soap:operation

soapAction=“http://example.org/CustomerExample/CustomerInfo”

style=“document” />

<wsdl:input>

<soap:body use=“literal” />

</wsdl:input>
<wsdl:output>

<soap:body use=“literal” />

</wsdl:output>

</wsdl:operation>

</wsdl:binding>
</wsdl:definitions>

The following is the corresponding SOAP message with contents of Photo serialized using base64 encoding:

<soap11:Envelope

xmlns:soap11=“http://schemas.xmlsoap.org/soap/envelope/”
xmlns:xmime=‘http://schemas.xmlsoap.org/2003/04/xmime’ >

<soap11:Body>

<d:Customer xmlns:d=“http://example.org/CustomerExample” >

<d:Name>John Doe</d:Name>
<d:Photo xmime:MediaType=“image/jpeg” >

/aWKKapGGyQ=

</d:Photo>

</d:Customer>

</soap11:Body>

</soap11:Envelope>

Alternatively, the message may use multipart MIME and an XML include element as described above:

MIME-Version: 1.0

Content-Type: Multipart/Related; boundary=MIME_boundary;
type=text/xml;
start=‘<mymessage.xml@example.org>’
Content-Description: A SOAP envelope containing a photo
--MIME_boundary
Content-Type: text/xml; charset=UTF-8
Content-Transfer-Encoding: 8bit
Content-ID: <mymessage.xml@example.org>
<soap11:Envelope

xmlns:soap11=‘http://schemas.xmls.org/soap/envelope/’
xmlns:xbinc=‘http://schemas.xmlsoap.org/2003/04/xbinc’
xmlns:xmime=‘http://schemas.xmlsoap.org/2003/04/xmime’ >

<soap11:Header>

<xbinc:DoInclude

soap11:actor=‘http://schemas.xmlsoap.org/soap/actor/next’

soap11:mustUnderstand=‘false’ />

</soap11:Header>
<soap11:Body>

<d:Customer xmlns:d=‘http://example.org/CustomerExample’ >

<d:Name>John Doe</d:Name>
<d:Photo xmime:MediaType=‘image/jpeg’ >

<xbinc:Include

href=‘cid:http://example.org/Customer.jpg’ />

</d:Photo

</d:Customer>

</soap11:Body>

</soap11:Envelope>
--MIME_boundary
Content-Type: image/jpeg
Content-Transfer-Encoding: binary
Content-ID: <http://example.org/Customer.jpg>
fd a5 8a 29 aa 46 1b 24
--MIME_boundary--

Given that SOAP processing occurs post inclusion, signatures over elements with XML include element children should not include signatures over the XML include element and corresponding href attribute. Rather, signatures should be over the included data. Current XML signature algorithms require signing the included data as base64-encoded characters; the lexical form of such characters is to be canonicalized, although an include-aware canonicalization algorithm may be able to eliminate the need to convert between the raw octets and base64-encoded characters.

In general, signatures should be against elements and their content, and not just the content of elements, to ensure the context is not altered. Specifically, if the xmime:MediaType attribute is used on an element, then it can be included in the signature to prevent certain types of attacks.

For security purposes, to ensure that the URI associated with a representation is not tampered with, the representation element and its URI attribute should be signed. References should be signed by a party who has the right to “speak for” the domain of the reference. Further, to reduce the risk of denial of service and elevated privilege, senders should not include, and receivers should discard, MIME parts that contain neither the SOAP Envelope nor are referenced by an XML include element from within the SOAP Envelope.

In another example embodiment, the homogenized data 120B of FIG. 3, resulting from the processing of FIG. 1, includes a sequence of one or more data fragments 305, 310, each data fragment potentially having a different character encoding, such as UTF-8 or UTF-16. Accordingly, each data fragment begins with a header indicating the character encoding and length (in octets) of the data in the corresponding fragment. FIG. 3 refers to the mixed content encoding combination technique, by which data having at least two different encodings is interleaved, i.e., combined, in accordance with a reference encoding.

Thus, format-specific encodings are defined for exclusive use by data fragments containing opaque binary data. Such encodings define how to map a sequence of octets into a lexical sequence of Unicode characters. However, such encodings typically make no attempt to provide representations for every possible Unicode character; rather, each encoding only supports the specific characters used by the associated binary-to-character set encoding schemes.

The Augmented Backus-Naur Form (ABNF) notation is used to formally define the data fragment format as follows:

fragment = <encoding> <length> <content>
octet = %x00-FF

Each of the encoding, length, and content fields is described below.

The encoding for a data fragment is indicated by an integer value, examples of which are provided as follows:

| Value | Description |
|---|---|
| 0-2999 | Character encodings indexed by IANA (Internet |
| | Assigned Numbers Authority)-registered MIB |
| | (Management Information Base) enum |
| 3000-8190 | Reserved |
| 8191 | Mixed content character encoding |
| 8192 | uuencode |
| 8193 | Quoted-Printable |
| 8194 | hexadecimal - each binary octet encoded as a |
| | character tuple consisting of two hexadecimal |
| | digits representing the octet code |
| 8195 | Base64 |
| 8196-65535 | Reserved |

The values from 0 to 2999 denote the MIB enum for character encodings registered with IANA. For instance, a value of 3 denotes a US-ASCII character encoding since it has a MIB enum of 3. Similarly, 106 denotes UTF-8, 1015 denotes UTF-16, 1014 denotes UTF-16LE (little-endian), and 4 denotes ISO-8859-1. MIB enum values in this range can be used as the value of a fragment encoding as specified in IANA.

More particular to the example embodiments described herein, the data fragment format of the example embodiment may be nested, indicated by a value of 8191 in the encoding field.

In addition, the values from 8192 to 8195 indicate well-known binary-to-character set encodings. For each value, the referenced specification defines how to map octets into Unicode (typically US-ASCII) characters. These values are defined herein to minimize the need for explicit binary-to-character set conversions when opaque binary data is included. They have no defined semantics outside the format defined herein and are not used independently. Lastly, the values from 8196 to 65535 are reserved and are not used.

The values included in the encoding field value are between 0 and 65535 inclusive and is implemented as an unsigned, 16-bit integer, expressed as one, two, or three octets.
encoding=1*3<octet>
   Further, encodings are not used to represent any processing rules that are not inherent from the context containing the data to thereby ensure that if only the original data is secured, the security of the data can be maintained.

The length of the contents of the data fragment is expressed in octets by an integer. The length field value is between 0 and 18,446,744,073,709,551,615 inclusive, and is implemented as an unsigned, 64-bit integer. The value is expressed as from one to ten octets inclusive.

length=1*10<octet>

The content field of the data fragment includes the content (value) of the data fragment, and interpretation of the content is based on the encoding field of the fragment header.
content=*<octet>

The encoding and length fields of the data fragment are expressed as one or more octets. The most-significant bit of each octet indicates whether another octet of the field follows. All but the last octet of the length field have the most-significant bit set (1), and the last octet of the length field has the most-significant bit clear (0).

The 7 remaining least-significant bits of each octet are combined together to indicate the integer value of the field. The algorithm for writing out the unsigned integer representing the field value is as follows:
the integer is written out 7 bits at a time, starting with the 7 least-significant bits;
if the integer fits in 7 bits, it takes only one octet of space, and the most-significant bit of the octet is clear; and
if the integer does not fit in 7 bits, the most-significant bit is set on the first octet.
The integer is shifted by 7 bits and the next octet is written. This process is repeated until the entire integer has been written.

For example, for a fragment with a length of 127 octets, the length field is a single octet (since 127<=2\hat{ }7) with a value of 0×7 F. For a fragment with a length of 128 octets, the length field would be two octets (since 2\hat{ }7<128<=2\hat{ }14); the first octet contains the least-significant 7 bits (0000000) with the most-significant bit set (1), or 0×80, and the second octet contains the most-significant 7 bits (0000001) with the most-significant bit clear (0), or 0×01.

The following example illustrates a format of the following text string that contains a string of hexadecimal characters:
Hello 00112233445566778899AABBCCDDEEFF world!

Assuming the text is encoded as UTF-8 and the 32 character binary information represents opaque, hex-encoded data, the above example text string is represented using three fragments as illustrated below:

| | |
|---|---|
| [UTF-8] | Hello[sp] |
| [hexadecimal] | sequence of sixteen octets |
| [UTF-8] | [sp]world! |

The physical representation of the format is as follows: in the listing, hex pairs are octets; line numbers and white space are inserted for clarity; characters followed by a double-slash are comments; and none appear in the encoding.

| (01) 6A | // UTF-8 fragment |
|---|---|
| (02) 06 | // 6 octets long |
| (03) 48 65 6C 6C 6F 20 | // “Hello ” |
| (04) 82 40 | // hex fragment |
| (05) 10 | // 16 octets long |
| (06) 00 11 22 33 44 55 66 77 88 99 AA BB CC DD EE FF | |
| (07) 6A | // UTF-8 fragment |
| (08) 07 | // 7 octets long |
| (09) 20 77 6F 72 6C 64 21 | // “ world!” |

Line (01) indicates a fragment encoded with UTF-8: the IANA MIB enum for UTF-8 is 106 (decimal) or 6A (hex); since this integer is less than 2\hat{ }7, only one octet is needed. Line (02) indicates the fragment is 6 octets long; this integer is also less than 2\hat{ }7 and uses only one octet. Line (03) contains the data for the fragment (i.e., “Hello”). Line (04) indicates a fragment encoded with hex, 8194 (decimal); this integer is greater than 2\hat{ }7 but less than 2\hat{ }14, and therefore requires two octets. Line (05) indicates a length of 16 octets. Line (06) contains the binary data. Lines (07, 08) indicate a fragment encoded with UTF-8 with length 7 octets. Line (09) contains the data (i.e., ♭world!”).

Like all formats, the information contained within is subject to a number of security risks such as alteration and replay. Therefore, steps should be taken to secure the data as necessary. For example, digital signatures may be used to ensure the integrity of the data.

The exact mechanisms needed to secure the data need not secure the meta-information used by the format because the details of the format do not convey additional semantics and the mechanisms to secure the data are at the raw octet level, so long as:
the context in which the data is used is not part of the format and is secured along with the data; and
the extension mechanisms within the format provide no semantic information that is not already secured with the data.

All secure usages of this format should take steps to ensure that the data is not modified and its original can be determined to the degree required. Furthermore, if the data is confidential, steps should be taken to ensure privacy such as encrypting the data.

The format defined herein may be used with any text-based MIME media type. To indicate that this format is in use, the character set parameter is “x-mixed-mode. ” For example, a plain text file using the format defined herein would be declared using the following MIME header:
Content-Type: text/plain; charset=x-mixed-mode

The following example illustrates a PostScript® document with embedded binary information which has been encoded in text:

8 8 1 [8 0 0 -8 0 8] {currentfile picstr readhexstring pop }
image BADDECAF00112233

Using the mechanisms defined within PostScript®, the raw binary can be embedded as follows:

8 8 1 [8 0 0 -8 0 8] {currentfile picstr readhexstring pop }
Image
%%BeginData: 8 Binary Bytes
10111010 11011101 .. 00110011
%%EndData

Using the format defined herein, the original example could be represented as follows: in the listing, hex pairs are octets, quoted strings represent sequential strings of characters; white space is inserted for clarity; and characters followed by a double-slash are comments; neither appears in the encoding.

| | |
|---|---|
| 6A 43 | // UTF-8 fragment 67 long |

“8 8 1 [8 0 0 -8 0 8] {currentfile picstr readhexstring pop } Image ”

| | |
|---|---|
| 82 40 08 | // hex fragment 8 long |
| BA DD .. 33 | // data |

The following example illustrates an RTF document with embedded binary information which has been encoded in text:
{\rtf1 Hello {\pict \pngblip BADDECAF00112233}World}

Using the mechanisms defined within RTF, the raw binary can be embedded as follows:

{\rtf1 Hello {\pict \pngblip \bin8
10111010 11011101 .. 00110011
} World }

Using the format defined herein, the result is as follows: in the listing, hex pairs are octets, quoted strings represent sequential strings of characters; white space is inserted for clarity; characters followed by a double-slash are comments; neither appears in the encoding.

| | |
|---|---|
| 6A 1D | // UTF-8 fragment 29 long |
| “{\rtf1 Hello {\pict \pngblip ” | // data |
| 82 40 08 | // hex fragment 8 long |
| BA DD EC AF 00 11 22 33 | // data |
| 6A 09 | // UTF-8 fragment 9 long |
| “} World }” | // data |

XML documents are another text format where efficiencies can be found by allowing embedded binary data rather than using the XML Schema base64Binary and hexBinary textual encodings. The format defined herein can be applied to XML as described below.

The following example illustrates XML with embedded binary using a hexadecimal textual encoding:
<e>00112233445566778899AABBCCDDEEFF</e>

This XML document could be formatted as follows: in the listing, hex pairs are octets; white space is inserted for clarity; characters followed by a double-slash are comments; neither appears in the encoding.

| 6A 03 | // UTF-8 fragment 3 long |
|---|---|
| 3C 65 3E | // “<e>” |
| 82 40 10 | // hex fragment 16 long |
| 00 11 22 33 44 55 66 77 88 99 aa bb cc dd ee ff | |
| 6A 04 | // UTF-8 fragment 4 long |
| 3C 2F 65 3E | // “</e>” |

A parsed entity may indicate the encoding in use either via an XML Declaration/Text Declaration or through out-of-band means. When using the format defined herein with an XML Declaration/Text declaration, the parsed entity begins with the octet sequence for the XML Declaration/Text Declaration followed by the first fragment.

The following example illustrates XML with embedded binary using a hexadecimal textual encoding and with an XML Declaration/Text declaration. In the listing, hex pairs are octets. Characters followed by a double-slash are comments and do not appear in the encoding.

| 3C 3F 78 6D 6C 20 76 65 | // <?xml ve |
|---|---|
| 72 73 69 6F 6E 3D 27 31 | // rsion=‘1 |
| 2E 30 27 20 65 63 63 6F | // .0’ enco |
| 64 69 63 67 3D 27 78 2D | // ding=‘x- |
| 6D 69 78 65 64 2D 6D 6F | // mixed-mo |
| 64 65 27 3F 3E | // de’?> |
| 6A 03 | // UTF-8 fragment 3 long |
| 3C 65 3E | // “<e>” |
| 82 40 10 | // hex fragment 16 long |
| 00 11 22 33 44 55 66 77 88 99 aa bb cc dd ee ff | |
| 6A 04 | // UTF-8 fragment 4 long |
| 3C 2F 65 3E | // “</e>” |

Because formats defined herein work below the entity layer of XML 1.0, the use of these formats do not impact the XML Information Set. Furthermore, technologies that are based on XML 1.0 and work above the entity layer (e.g., XML C14N, XML Signature, XML Encryption) are not impacted by the use of such formats.

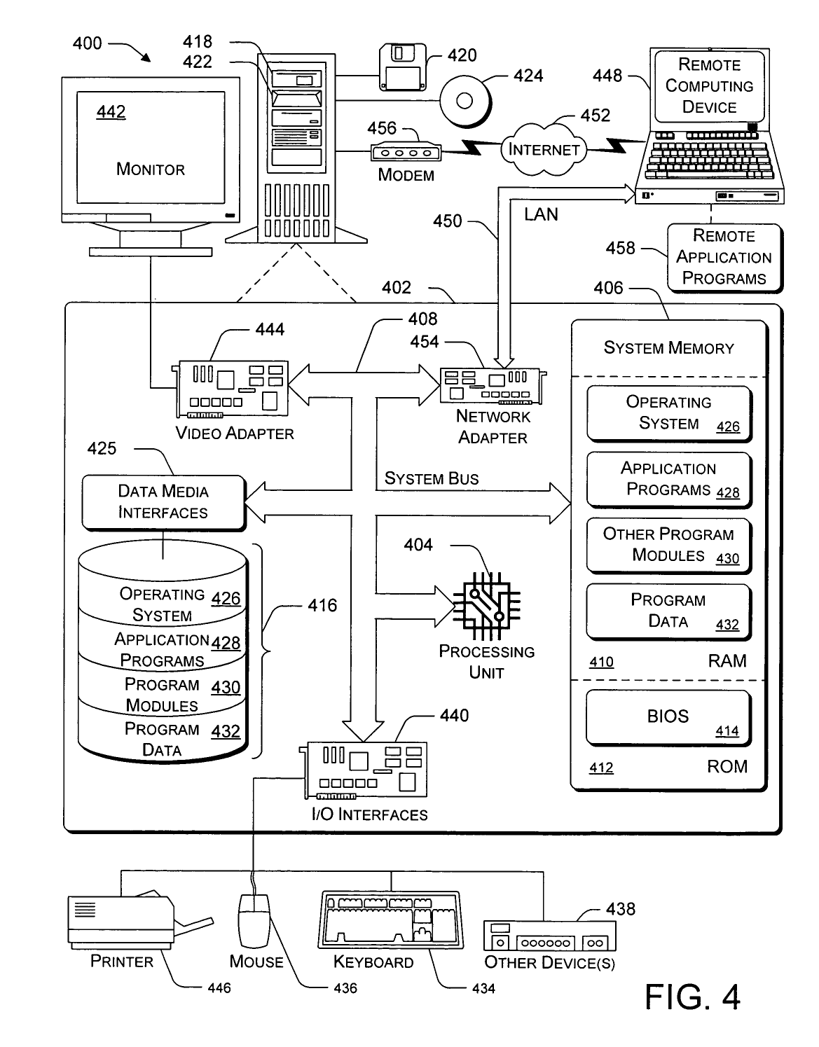

FIG. 4 illustrates a general computer environment 400, which can be used to implement the techniques described herein. The computer environment 400 is only one example of a computing environment and is not intended to suggest any limitation as to the scope of use or functionality of the computer and network architectures. Neither should the computer environment 400 be interpreted as having any dependency or requirement relating to any one or combination of components illustrated in the example computer environment 400.

Computer environment 400 includes a general-purpose computing device in the form of a computer 402. The components of computer 402 can include, but are not limited to, one or more processors or processing units 404, system memory 406, and system bus 408 that couples various system components including processor 404 to system memory 406.

System bus 408 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394, i.e., FireWire, bus.

Computer 402 may include a variety of computer readable media. Such media can be any available media that is accessible by computer 402 and includes both volatile and non-volatile media, removable and non-removable media. In addition, such media are capable of receiving and storing the data 120, 120A, and 120B, combined as described above.

System memory 406 includes computer readable media in the form of volatile memory, such as random access memory (RAM) 410; and/or non-volatile memory, such as read only memory (ROM) 412 or flash RAM. Basic input/output system (BIOS) 414, containing the basic routines that help to transfer information between elements within computer 402, such as during start-up, is stored in ROM 412 or flash RAM. RAM 410 typically contains data and/or program modules that are immediately accessible to and/or presently operated on by processing unit 404.

Computer 402 may also include other removable/non-removable, volatile/non-volatile computer storage media. By way of example, FIG. 4 illustrates hard disk drive 416 for reading from and writing to a non-removable, non-volatile magnetic media (not shown), magnetic disk drive 418 for reading from and writing to removable, non-volatile magnetic disk 420 (e.g., a “floppy disk”), and optical disk drive 422 for reading from and/or writing to a removable, non-volatile optical disk 424 such as a CD-ROM, DVD-ROM, or other optical media. Hard disk drive 416, magnetic disk drive 418, and optical disk drive 422 are each connected to system bus 408 by one or more data media interfaces 425. Alternatively, hard disk drive 416, magnetic disk drive 418, and optical disk drive 422 can be connected to the system bus 408 by one or more interfaces (not shown).

The disk drives and their associated computer-readable media provide non-volatile storage of computer readable instructions, program modules, and data structures such as data 120, 120A, and 120B described above, for computer 402. Although the example illustrates a hard disk 416, removable magnetic disk 420, and removable optical disk 424, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 416, magnetic disk 420, optical disk 424, ROM 412, and/or RAM 410, including by way of example, operating system 426, one or more application programs 428, other program modules 430, and program data 432. Each of such operating system 426, one or more application programs 428, other program modules 430, and program data 432 (or some combination thereof) may implement all or part of the resident components that support the distributed file system.

A user can enter commands and information into computer 402 via input devices such as keyboard 434 and a pointing device 436 (e.g., a “mouse”). Other input devices 438 (not shown specifically) may include a microphone, joystick, game pad, satellite dish, serial port, scanner, and/or the like. These and other input devices are connected to processing unit 404 via input/output interfaces 440 that are coupled to system bus 408, but may be connected by other interface and bus structures, such as a parallel port, game port, or a universal serial bus (USB).

Monitor 442 or other type of display device can also be connected to the system bus 408 via an interface, such as video adapter 444. In addition to monitor 442, other output peripheral devices can include components such as speakers (not shown) and printer 446 which can be connected to computer 402 via I/O interfaces 440.

Computer 402 can operate in a networked environment using logical connections to one or more remote computers, such as remote computing device 448. By way of example, remote computing device 448 can be a PC, portable computer, a server, a router, a network computer, a peer device or other common network node, and the like. Remote computing device 448 is illustrated as a portable computer that can include many or all of the elements and features described herein relative to computer 402. Alternatively, computer 402 can operate in a non-networked environment as well.

Logical connections between computer 402 and remote computer 448 are depicted as a local area network (LAN) 450 and a general wide area network (WAN) 452. Such networking environments are commonplace in offices, enterprise-wide computer networks, intranets, and the Internet.

When implemented in a LAN networking environment, computer 402 is connected to local network 450 via network interface or adapter 454. When implemented in a WAN networking environment, computer 402 typically includes modem 456 or other means for establishing communications over wide network 452. Modem 456, which can be internal or external to computer 402, can be connected to system bus 408 via I/O interfaces 440 or other appropriate mechanisms. It is to be appreciated that the illustrated network connections are examples and that other means of establishing at least one communication link between computers 402 and 448 can be employed.

In a networked environment, such as that illustrated with computing environment 400, program modules depicted relative to computer 402, or portions thereof, may be stored in a remote memory storage device. By way of example, remote application programs 458 reside on a memory device of remote computer 448. For purposes of illustration, applications or programs and other executable program components such as the operating system are illustrated herein as discrete blocks, although it is recognized that such programs and components reside at various times in different storage components of computing device 402, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer, such as data 120, 120A, and 120B described above.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various changes to those skilled in the art may be made in the details of the present invention disclosed herein without departing from the scope of the claimed invention.

1. A method of combining formats for an electronic file, comprising:
combining data having at least two different encodings; and
presenting the combined data as homogenized data according to a reference encoding.

2. A method according to claim 1, wherein the reference encoding includes at least one of the at least two different encodings.

3. A method according to claim 2, wherein the reference encoding is XML.

4. A method according to claim 3, wherein the combined data is encoded into a single XML information set.

5. A method according to claim 1, wherein the combining comprises referring to data.

6. A method according to claim 1, wherein the combining comprises interleaving data.

7. A method according to claim 5, wherein the combining comprises referring to data using an include element to reference binary data.

8. A method according to claim 7, wherein a href (Hypertext REFerence) attribute of the include element provides a universal resource identifier of the binary data to be referenced.

9. A method according to claim 5, wherein the combined data is presented as a MIME serialization.

10. A method according to claim 7, wherein the include element comprises a simple object access protocol (SOAP) header block.

11. A method according to claim 10, wherein the SOAP header block indicates that the combined data includes the XML include element, and points to cached representations of media resources.

12. A method according to claim 11, wherein the SOAP header block points to any one of a web resource, an audio resource, and an image resource.

13. A method according to claim 6, wherein the combining comprises combining data fragments, each data fragment being defined by values corresponding to a respective encoding, length, and content.

14. A method according to claim 13, wherein a data fragment is notated as <encoding><length><content>.

15. A computer-readable medium having stored thereon a data structure, comprising:
a first data field encoded according to a first format; and
a second data field referring to data encoded according to a second format,
wherein the first data field and the second data field are homogenized according to a reference encoding format.

16. A computer-readable medium according to claim 15, wherein the reference encoding is XML.

17. A computer-readable medium according to claim 15, wherein the homogenized data is encoded into a single XML information set.

18. A computer-readable medium according to claim 15, wherein at least one of the first data field and the second data field comprises an include element to reference binary data.

19. A computer-readable medium according to claim 15, wherein a href attribute of the include element provides a universal resource identifier of the binary data to be referenced.

20. A computer-readable medium according to claim 15, wherein at least one of the first data field and the second data field comprises an include element to reference one of a web resource, an audio resource, and an image resource.

21. A computer-readable medium having stored thereon a data structure, comprising:
a first data fragment encoded according to a first format; and
a second data fragment encoded according to a second data format,
wherein the first data field and the second data field are homogenized according to a reference encoding format.

22. A computer-readable medium according to claim 21, wherein the reference encoding is XML.

23. A computer-readable medium according to claim 22, wherein the homogenized data is encoded into a single XML information set.

24. A computer-readable medium according to claim 21, wherein both the first and the second data fragment are defined by values corresponding to a respective encoding, length, and content.

25. A computer-readable medium according to claim 24, wherein both the first data fragment and the second data fragment are formatted as <encoding><length><content>.

26. A method of transmitting data to a receiving node, comprising:
combining data having at least two different encodings;
homogenizing the combined data in accordance with a reference encoding; and
transmitting homogenized data to the receiving node over a network.

27. A method according to claim 26, wherein the reference encoding includes at least one of the at least two different encodings.

28. A method according to claim 27, wherein the reference encoding is XML.

29. A method according to claim 28, wherein the combined data is homogenized into a single XML information set.

30. A method according to claim 26, wherein the combining includes resolving to data.

31. A method according to claim 26, wherein the combining includes interleaving data.

32. A method according to claim 30, wherein the combining includes resolving to data using an include element to reference binary data.

33. A method according to claim 32, wherein an attribute of the include element provides a universal resource identifier of the binary data to be resolved.

34. A method according to claim 30, wherein the combined data is presented as a MIME serialization.

35. A method according to claim 32, wherein the include element resolves to cached representations of media resources.

36. A method according to claim 35, wherein the cached representations of media resources are cached separately from the include element.

37. A method according to claim 35, wherein the include element resolves to any one of a web resource, an audio resource, and an image resource.

38. A method according to claim 26, wherein the combining includes combining data fragments, each data fragment being defined by values corresponding to a respective encoding, length, and content.

39. A method according to claim 26, wherein a data fragment is notated as <encoding><length><content>.
